(19) United States
(12) Patent Application Publication
(10) Pub. No.: US 2023/0161153 A1
(43) Pub. Date: May 25, 2023

(54) OPTICAL SCANNING DEVICE AND DISTANCE MEASURING DEVICE

(71) Applicant: Mitsubishi Electric Corporation, Tokyo (JP)

(72) Inventors: Nobuaki KONNO, Chiyoda ku, Tokyo (JP); Takahiko ITO, Chiyoda ku, Tokyo (JP)

(73) Assignee: Mitsubishi Electric Corporation, Tokyo (JP)

(21) Appl. No.: 17/916,803

(22) PCT Filed: May 12, 2020
(86) PCT No.: PCT/JP2020/018997

§ 371 Date: Oct. 4, 2022

(51) Int. Cl. G02B 26/10; G02B 26/08; G01S 7/481

(52) U.S. Cl. CPC G02B 26/105; G02B 26/106; G02B 26/0858; G01S 7/4812

(57) ABSTRACT

An optical scanning device includes a substrate and a plurality of movable mirror elements. The substrate includes a main surface. The plurality of movable mirror elements are two-dimensionally arranged on the main surface of the substrate. The plurality of movable mirror elements are capable of operating independently of each other and capable of forming a diffraction grating. Each of the plurality of movable mirror elements includes a beam, a movable mirror, and a pillar. The beam is bendable in a direction perpendicular to the main surface. The movable mirror includes a movable plate and a mirror film disposed on the movable plate. The pillar connects the movable plate and the beam to each other.

### TECHNICAL FIELD

The present disclosure relates to an optical scanning device and a distance measuring device.

### BACKGROUND ART

Japanese Patent No. 2722314 (PTL 1) discloses a planar galvanometer mirror. The planar galvanometer mirror includes a semiconductor substrate, a movable plate, a mirror provided on the movable plate, and a torsion bar that swingably supports the movable plate on the semiconductor substrate.

### CITATION LIST

### Patent Literature

PTL 1: Japanese Patent No. 2722314

### SUMMARY OF INVENTION

### Technical Problem

In the galvanometer mirror described above, the mirror unit including the movable plate and the mirror film is driven by the resonance frequency of the mirror unit to scan a light beam at a large deflection angle as fast as possible. However, in order to prevent torsional rupture of the torsion bar, the deflection angle of the galvanometer mirror is limited to an angle less than 20° at the maximum. The light beam incident on the galvanometer mirror is received by a single mirror. As a result, the size and the mass of the mirror unit become large, and thereby there is a limit to speeding up the optical scanning using the galvanometer mirror.

The present disclosure has been made to solve the aforementioned problems, and an object of an aspect of the present disclosure is to provide an optical scanning device capable of performing an optical scanning with a light beam at a higher speed and a larger deflection angle. Another object of the present disclosure is to provide a distance measuring device capable of measuring an ambient distance more quickly and more easily.

### Solution to Problem

The optical scanning device of the present disclosure includes a substrate and a plurality of movable mirror elements. The substrate includes a main surface that extends in a first direction and a second direction perpendicular to the first direction. The plurality of movable mirror elements are two-dimensionally arranged on the main surface of the substrate in a plan view of the main surface of the substrate. The plurality of movable mirror elements are capable of operating independently of each other and capable of forming a diffraction grating. Each of the plurality of movable mirror elements includes a beam, a first anchor, a second anchor, a movable mirror, and a pillar. The beam is bendable in a third direction perpendicular to the main surface. The first anchor is provided on the main surface of the substrate to support a first end of the beam. The second anchor is provided on the main surface of the substrate to support the second end of the beam opposite to the first end. The movable mirror includes a movable plate separated from the beam in the third direction, and a mirror film disposed on the movable plate. The pillar connects the movable plate and a portion of the beam other than the first end and the second end to each other.

The distance measuring device of the present disclosure includes the optical scanning device of the present disclosure.

### Advantageous Effects of Invention

In the optical scanning device of the present disclosure, the light beam incident on the optical scanning device is received by the movable mirror of each of the plurality of movable mirror elements. Thus, it is possible to reduce the size and mass of each movable mirror, which makes it possible to move each movable mirror at a higher speed. Therefore, it is possible for the optical scanning device to perform an optical scanning with a light beam at a higher speed. Further, in the optical scanning device, the light beam incident on the optical scanning device is deflected by using a diffraction grating formed from a plurality of movable mirror elements capable of operating independently of each other. Therefore, it is possible for the optical scanning device to perform an optical scanning with a light beam at a larger deflection angle.

The distance measuring device of the present disclosure includes the optical scanning device of the present disclosure capable of performing an optical scanning with a light beam at a higher speed. Therefore, it is possible for the distance measuring device to measure the ambient distance more quickly. The distance measuring device of the present disclosure includes the optical scanning device of the present disclosure capable of perform an optical scanning with a light beam at a larger deflection angle. Therefore, it is possible for the distance measuring device to measure the ambient distance more easily.

### BRIEF DESCRIPTION OF DRAWINGS

FIG. 1 is a schematic view illustrating an optical scanning device according to a first embodiment, a third embodiment and a fourth embodiment;

FIG. 2 is a partially enlarged schematic perspective view illustrating the optical scanning device according to the first embodiment;

FIG. 3 is a partially enlarged schematic cross-sectional view illustrating the optical scanning device of the first embodiment taken along a cross-sectional line illustrated in FIGS. 5 and 6;

FIG. 4 is a partially enlarged schematic cross-sectional view illustrating the optical scanning device according to the first embodiment;

FIG. 5 is a partially enlarged schematic plan view illustrating the optical scanning device according to the first embodiment;

FIG. 6 is a partially enlarged schematic plan view illustrating the optical scanning device according to the first embodiment;

FIG. 7 is a schematic enlarged side view illustrating the optical scanning device according to the first embodiment;

FIG. 8 is a partially enlarged schematic perspective view illustrating the optical scanning device according to the first embodiment;

FIG. 9 is a partially enlarged schematic perspective view illustrating the optical scanning device according to the first embodiment;

FIG. 10 is a partially enlarged schematic cross-sectional view illustrating a step in a manufacturing method of the optical scanning device according to the first embodiment;

FIG. 11 is a partially enlarged schematic cross-sectional view illustrating a step subsequent to the step illustrated in FIG. 10 in the manufacturing method of the optical scanning device according to the first embodiment;

FIG. 12 is a partially enlarged schematic cross-sectional view illustrating a step subsequent to the step illustrated in FIG. 11 in the manufacturing method of the optical scanning device according to the first embodiment;

FIG. 13 is a partially enlarged schematic cross-sectional view illustrating a step in the manufacturing method of the optical scanning device according to the first embodiment;

FIG. 14 is a partially enlarged schematic cross-sectional view illustrating a step subsequent to the step illustrated in FIG. 13 in the manufacturing method of the optical scanning device according to the first embodiment;

FIG. 15 is a partially enlarged schematic cross-sectional view illustrating a step subsequent to the step illustrated in FIGS. 12 and 14 in the manufacturing method of the optical scanning device according to the first embodiment;

FIG. 16 is a partially enlarged schematic cross-sectional view illustrating a step subsequent to the step illustrated in FIG. 15 in the manufacturing method of the optical scanning device according to the first embodiment;

FIG. 17 is a partially enlarged schematic perspective view illustrating an optical scanning device according to a modification of the first embodiment;

FIG. 18 is a partially enlarged schematic perspective view illustrating an optical scanning device according to a modification of the first embodiment;

FIG. 19 is a partially enlarged schematic perspective view illustrating an optical scanning device according to a modification of the first embodiment;

FIG. 20 is a schematic view illustrating an optical scanning device according to a second embodiment;

FIG. 21 is a partially enlarged schematic plan view illustrating the optical scanning device according to the second embodiment;

FIG. 22 is a partially enlarged schematic plan view illustrating an optical scanning device according to a third embodiment;

FIG. 23 is a partially enlarged schematic plan view illustrating an optical scanning device according to a fourth embodiment;

FIG. 24 is a schematic view illustrating an optical scanning device according to a fifth embodiment;

FIG. 25 is a partially enlarged schematic cross-sectional view illustrating an optical scanning device according to a fifth embodiment;

FIG. 26 is a schematic view illustrating a distance measuring device according to a sixth embodiment; and

FIG. 27 is a schematic block view illustrating a controller included in the distance measuring device according to the sixth embodiment.

### DESCRIPTION OF EMBODIMENTS

Hereinafter, embodiments of the present disclosure will be described. The same components are denoted by the same reference numerals, and the description thereof will not be repeated.

### First Embodiment

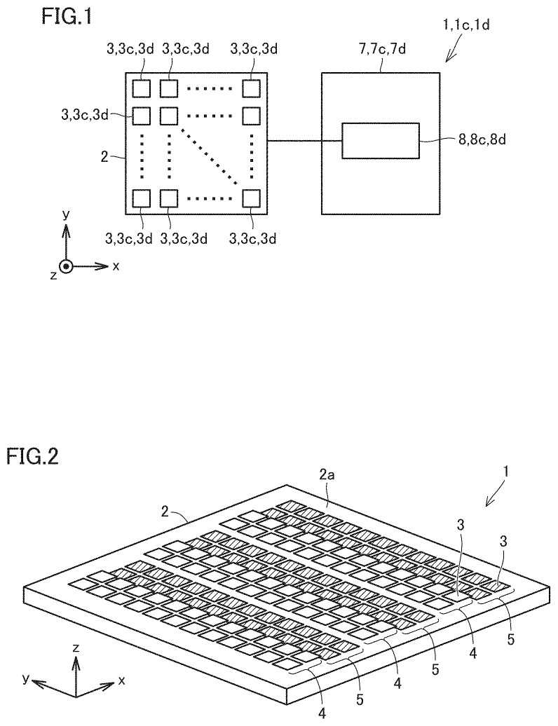

An optical scanning device 1 according to a first embodiment will be described with reference to FIGS. 1 to 6. The optical scanning device 1 includes a substrate 2, a plurality of movable mirror elements 3, and a controller 7.

The substrate 2 includes a main surface 2a that extends in a first direction (x direction) and a second direction (y direction) perpendicular to the first direction (x direction). The substrate 2 has a thickness of, for example, 100 μm or more and 1000 μm or less.

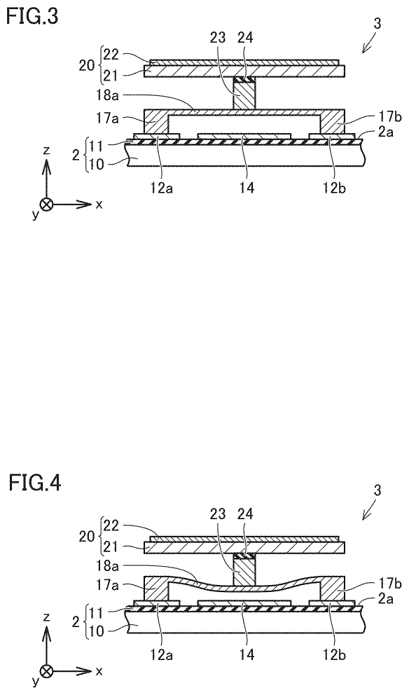

As illustrated in FIGS. 3 and 4, in the present embodiment, the substrate 2 includes a conductive substrate 10 and a first insulating film 11 provided on the conductive substrate 10. The conductive substrate 10 is, for example, a silicon substrate containing a dopant, and the first insulating film 11 is, for example, a silicon nitride film, a silicon dioxide film, or a laminated film of a silicon nitride film and a silicon dioxide film. The substrate 2 may be an insulating substrate. The first insulating film 11 has a thickness of, for example, 0.01 μm or more and 1.0 μm or less. When the substrate 2 is an insulating substrate, the first insulating film 11 may be dispensed with.

In a plan view of the main surface 2a of the substrate 2, the plurality of movable mirror elements 3 are two-dimensionally arranged on the main surface 2a of the substrate 2. The plurality of movable mirror elements 3 are capable of operating independently of each other and capable of forming a diffraction grating. Each of the plurality of movable mirror elements 3 includes an electrode 12a, an electrode 12b, a wiring 13a, a wiring 13b, an electrode 14, a wiring 15, an anchor 17a, an anchor 17b, a beam 18a, a movable mirror 20, and a pillar 23. Each of the plurality of movable mirror elements 3 may further include an electrode 12c, an electrode 12d, a wiring 13c, a wiring 13d, an anchor 17c, an anchor 17d, and a beam 18b.

The electrode 12a and the electrode 12b are provided on the main surface 2a of the substrate 2. Specifically, the electrode 12a and the electrode 12b are provided on the first insulating film 11, and are separated from each other. The wiring 13a and the wiring 13b are provided on the main surface 2a of the substrate 2. Specifically, the wiring 13a and the wiring 13b are provided on the first insulating film 11. The wiring 13a is connected to the electrode 12a, and is configured to supply a voltage to the electrode 12a. The wiring 13b is connected to the electrode 12b, and is configured to supply a voltage to the electrode 12b. Each of the electrode 12a, the electrode 12b, the wiring 13a, and the wiring 13b is made of, for example, conductive polysilicon or a metal such as aluminum, gold or platinum. Each of the electrode 12a, the electrode 12b, the wiring 13a, and the wiring 13b has a thickness of, for example, 0.10 μm or more and 10 μm or less.

The electrode 12c and the electrode 12d are provided on the main surface 2a of the substrate 2. Specifically, the electrode 12c and the electrode 12d are provided on the first insulating film 11, and are separated from each other. The wiring 13c and the wiring 13d are provided on the main surface 2a of the substrate 2. Specifically, the wiring 13c and the wiring 13d are provided on the first insulating film 11. The wiring 13c is connected to the electrode 12c, and is configured to supply a voltage to the electrode 12c. The wiring 13d is connected to the electrode 12d, and is configured to supply a voltage to the electrode 12d. Each of the electrode 12c, the electrode 12d, the wiring 13c, and the wiring 13d is made of, for example, conductive polysilicon or a metal such as aluminum, gold or platinum. Each of the electrode 12c, the electrode 12d, the wiring 13c, and the wiring 13d has a thickness of, for example, 0.10 μm or more and 10 μm or less.

The electrode 14 is provided on the main surface 2a of the substrate 2. Specifically, the electrode 14 is provided on the first insulating film 11 and is electrically insulated from the electrodes 12a and 12b and the electrodes 12c and 12d.

The electrode 14 is opposed to the pillar 23 in a third direction (z direction). The wiring 15 is provided on the main surface 2a of the substrate 2. Specifically, the wiring 15 is provided on the first insulating film 11. The wiring 15 is connected to the electrode 14, and is configured to supply a voltage to the electrode 14. The electrode 14 and the wiring 15 are made of, for example, conductive polysilicon or a metal such as aluminum, gold or platinum. Each of the electrode 14 and the wiring 15 has a thickness of, for example, 0.10 μm or more and 10 μm or less.

The anchor 17a and the anchor 17b are provided on the main surface 2a of the substrate 2. Specifically, the anchor 17a is provided on the electrode 12a, and is provided on the main surface 2a of the substrate 2 via the electrode 12a. The anchor 17b is provided on the electrode 12b, and is provided on the main surface 2a of the substrate 2 via the electrode 12b. The anchor 17a and the anchor 17b support the beam 18a. Specifically, the anchor 17a supports a first end of the beam 18a. The anchor 17b supports a second end of the beam 18a opposite to the first end of the beam 18a. The anchor 17a and the anchor 17b may be electrically conductive. Each of the anchor 17a and the anchor 17b is made of, for example, conductive polysilicon. The anchor 17a is electrically connected to the electrode 12a. The anchor 17b is electrically connected to the electrode 12b.

The anchor 17c and the anchor 17d are provided on the main surface 2a of the substrate 2. Specifically, the anchor 17c is provided on the electrode 12c, and is provided on the main surface 2a of the substrate 2 via the electrode 12c. The anchor 17d is provided on the electrode 12d, and is provided on the main surface 2a of the substrate 2 via the electrode 12d. The anchor 17c and the anchor 17d support the beam 18b. Specifically, the anchor 17c supports a third end of the beam 18b. The anchor 17d supports a fourth end of the beam 18b opposite to the third end of the beam 18b. The anchor 17c and the anchor 17d may be electrically conductive. Each of the anchor 17c and the anchor 17d is made of, for example, conductive polysilicon. The anchor 17c is electrically connected to the electrode 12c. The anchor 17d is electrically connected to the electrode 12d.

As illustrated in FIGS. 3 and 4, the beam 18a is bendable in the third direction (z direction) perpendicular to the main surface 2a of the substrate 2. The beam 18a is fixed to the substrate 2 by the anchor 17c and the anchor 17d. Specifically, the first end of the beam 18a is supported by the anchor 17a. The second end of the beam 18a is supported by the anchor 17b. The beam 18a may be electrically conductive. The beam 18a is made of, for example, conductive polysilicon. The beam 18a is electrically connected to the electrode 12a via the anchor 17a. The beam 18a is electrically connected to the electrode 12b via the anchor 17b.

The beam 18b is bendable in the third direction (z direction) perpendicular to the main surface 2a of the substrate 2. The beam 18b is fixed to the substrate 2 by the anchor 17c and the anchor 17d. Specifically, the third end of the beam 18b is supported by the anchor 17c. The fourth end of the beam 18b is supported by the anchor 17d. The beam 18b may be electrically conductive. The beam 18b is made of, for example, conductive polysilicon. The beam 18b is electrically connected to the electrode 12c via the anchor 17c. The beam 18b is electrically connected to the electrode 12d via the anchor 17d.

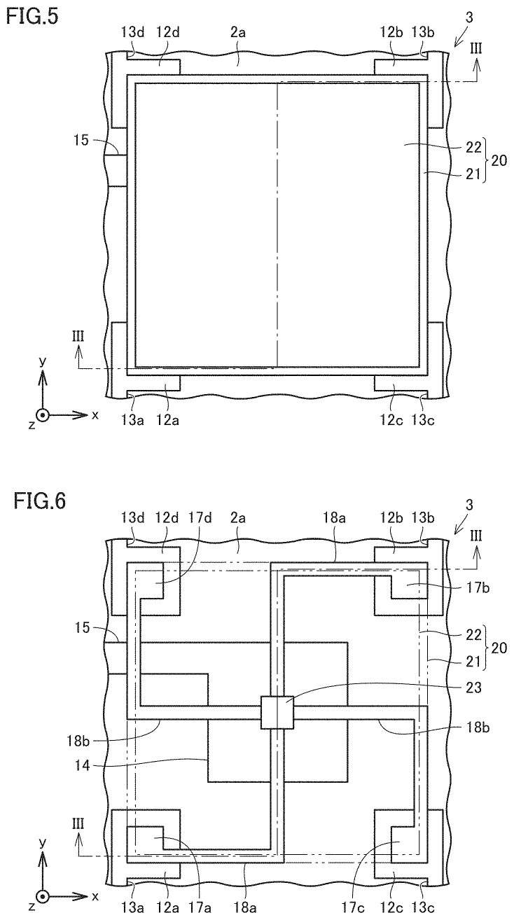

As illustrated in FIG. 6, in a plan view of the main surface 2a of the substrate 2, the longitudinal direction of the beam 18b at a portion of the beam 18b connected to the pillar 23 intersects the longitudinal direction of the beam 18a at a portion of the beam 18a connected to the pillar 23. Specifically, in the plan view of the main surface 2a of the substrate 2, the longitudinal direction of the beam 18b at the portion of the beam 18b connected to the pillar 23 is perpendicular to the longitudinal direction of the beam 18a at the portion of the beam 18a connected to the pillar 23. Specifically, in the plan view of the main surface 2a of the substrate 2, the longitudinal direction of the beam 18a at the portion of the beam 18a connected to the pillar 23 is the second direction (y direction). In the plan view of the main surface 2a of the substrate 2, the longitudinal direction of the beam 18b at the portion of the beam 18b connected to the pillar 23 is the first direction (x direction).

In the plan view of the main surface 2a of the substrate 2, the movable mirror 20 has, for example, a square shape. The movable mirror 20 includes a movable plate 21 and a mirror film 22. The movable plate 21 is separated from the beam 18a in the third direction (z direction). The movable plate 21 is separated from the beam 18b in the third direction (z direction). The movable plate 21 is made of, for example, conductive silicon. The mirror film 22 is provided on the movable plate 21. The mirror film 22 is, for example, a Cr/Ni/Au film or a Ti/Pt/Au film. The Cr film and the Ti film improve adhesion of the mirror film 22 to the movable plate 21 made of silicon. Since the uppermost layer of the mirror film 22 is an Au film, the mirror film 22 has a high reflectivity for a light beam incident on the optical scanning device 1.

The longitudinal direction of the pillar 23 is the third direction (z direction). The pillar 23 connects the movable plate 21 to a portion of the beam 18a other than the first end of the beam 18a and the second end of the beam 18a to each other. Specifically, the portion of the beam 18a is a central portion of the beam 18a, and the pillar 23 is connected to the central portion of the beam 18a. The pillar 23 connects the movable plate 21 and a portion of the beam 18b other than the third end of the beam 18b and the fourth end of the beam 18b to each other. Specifically, the portion of the beam 18b is a central portion of the beam 18b, and the pillar 23 is connected to the central portion of the beam 18b. The pillar 23 is connected to a back surface of the movable plate 21 opposite to a front surface of the movable plate 21 on which the mirror film 22 is provided. The pillar 23 may be connected to the back surface of the movable plate 21 via a second insulating film 24. The pillar 23 is made of, for example, conductive silicon. The second insulating film 24 is, for example, a silicon dioxide film.

The pillar 23 and the portion of the beam 18a connected to the pillar 23 are opposed to the electrode 14 in the third direction (z direction). The pillar 23 and the portion of the beam 18b connected to the pillar 23 are opposed to the electrode 14 in the third direction (z direction). The movable mirror 20 and the pillar 23 are supported by the beam 18a. The movable mirror 20 and the pillar 23 may be supported by the beam 18a and the beam 18b. Since the movable mirror 20 and the pillar 23 are supported by the beam 18a and the beam 18b, it is possible to more reliably set the displacement direction of the movable mirror 20 to the third direction (z direction) perpendicular to the substrate 2.

The controller 7 includes, for example, a semiconductor processor such as a central processing unit (CPU). The controller 7 controls a vertical displacement amount of the movable mirror 20 in the third direction (z direction) so as to form a diffraction grating from the plurality of movable mirror elements 3.

Specifically, as illustrated in FIG. 1, the controller 7 includes a voltage control unit 8. The voltage control unit 8 is connected to the electrodes 12a and 12b via the wirings 13a and 13b. The voltage control unit 8 is connected to the electrodes 12c and 12d via the wirings 13c and 13d. The beam 18a is electrically connected to the electrode 12a via the anchor 17a. The beam 18a is electrically connected to the electrode 12b via the anchor 17b. Specifically, the electrode 12a is electrically connected to the first end of the beam 18a via the anchor 17a. The electrode 12b is electrically connected to the second end of the beam 18a opposite to the first end of the beam 18a via the anchor 17b.

The beam 18b is electrically connected to the electrode 12c via the anchor 17c. The beam 18b is electrically connected to the electrode 12d via the anchor 17d. Specifically, the electrode 12c is electrically connected to the third end of the beam 18b via the anchor 17c. The electrode 12d is electrically connected to the fourth end of the beam 18b opposite to the third end of the beam 18b via the anchor 17d. The voltage controller 8 controls the voltage of the beam 18a electrically connected to the electrodes 12a and 12b. The voltage controller 8 controls the voltage of the beam 18b electrically connected to the electrodes 12c and 12d.

The voltage control unit 8 is connected to the electrode 14 via the wiring 15. The voltage control unit 8 controls the voltage of the electrode 14. Thus, the voltage control unit 8 controls the voltage between the beam 18a and the electrode 14. The voltage controller 8 controls the voltage between the beam 18b and the electrode 14. Thus, the controller 7 can control a vertical displacement amount of the movable mirror 20 in the third direction (z direction).

For example, the voltage between the beam 18a and the electrode 14 of a non-hatched movable mirror element 3 in FIG. 2 is relatively lower than that of a hatched movable mirror element 3 in FIG. 2. As illustrated in FIG. 3, the vertical displacement amount of the movable mirror 20 of a non-hatched movable mirror element 3 in FIG. 2 is a first vertical displacement amount. Specifically, the voltage between the beam 18a and the electrode 14 of a non-hatched movable mirror element 3 in FIG. 2 is zero, and no electrostatic attractive force acts between the beam 18a and the electrode 14. The beam 18a of a non-hatched movable mirror element 3 in FIG. 2 is not bent, and thereby the first vertical displacement amount of the movable mirror 20 is zero.

On the other hand, as illustrated in FIG. 4, a second vertical displacement amount of the movable mirror 20 of a hatched movable mirror element 3 in FIG. 2 is larger than the first vertical displacement amount. In the third direction (z direction), the movable mirror 20 of a hatched movable mirror element 3 in FIG. 2 is closer to the main surface 2a of the substrate 2 than the movable mirror 20 of a non-hatched movable mirror element 3 in FIG. 2. Specifically, in a hatched movable mirror element 3 in FIG. 2, the voltage between the beam 18a and the electrode 14 is non-zero, and thereby an electrostatic attractive force acts between the beam 18a and the electrode 14. In a hatched movable mirror element 3 of FIG. 2, the beam 18a is bent toward the main surface 2a of the substrate 2, and the second vertical displacement amount of the movable mirror 20 is larger than the first vertical displacement amount. Those described above with respect to the beam 18a also applies to the beam 18b.

As illustrated in FIG. 2, the controller 7 constructs a plurality of first movable mirror arrays 4 and a plurality of second movable mirror arrays 5 from the plurality of movable mirror elements 3. The plurality of first movable mirror arrays 4 are constructed from a part of the plurality of movable mirror elements 3 in which the vertical displacement amount of the movable mirror 20 is the first vertical displacement amount. The plurality of second movable mirror arrays 5 are constructed from the remaining part of the plurality of movable mirror elements 3 in which the vertical displacement amount of the movable mirror 20 is the second vertical displacement amount which is larger than the first vertical displacement amount. In the plan view of the main surface 2a of the substrate 2, a first longitudinal direction of each of the plurality of first movable mirror arrays 4 is parallel to a second longitudinal direction of each of the plurality of second movable mirror arrays 5. The plurality of first movable mirror arrays 4 and the plurality of second movable mirror arrays 5 are arranged alternately and periodically in a direction perpendicular to the first longitudinal direction. Thus, the plurality of movable mirror elements 3 can form a diffraction grating.

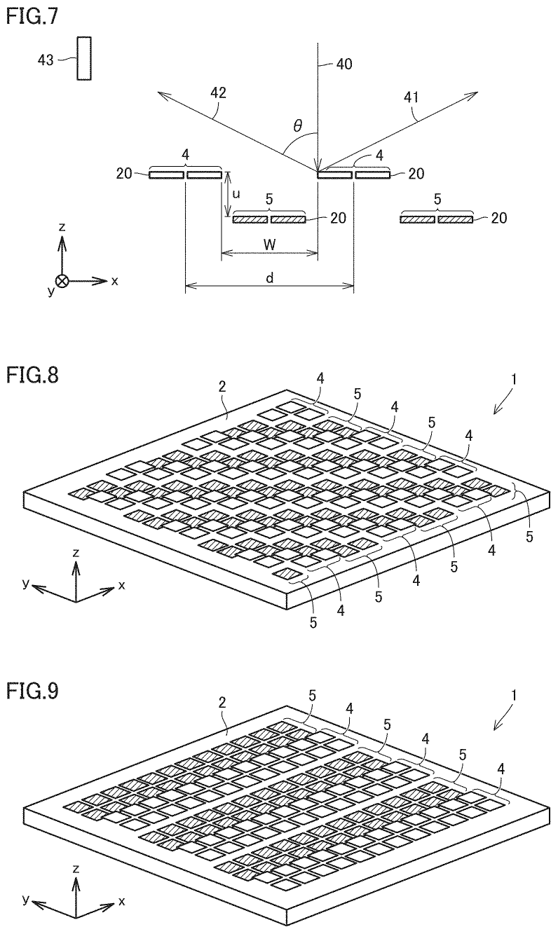

As illustrated in FIG. 7, a light beam 40 is incident on the movable mirrors 20 of the plurality of movable mirror elements 3 in the third direction (z direction). The light beam 40 is diffracted by the diffraction grating formed by the movable mirrors 20 of the plurality of movable mirror elements 3. A diffraction angle θ of the light beam diffracted by the plurality of movable mirror elements 3, that is, a deflection angle of the optical scanning device 1 is given by the following equation (1). The diffraction angle θ is defined as an angle between the light beam 40 incident on the plurality of movable mirror elements 3 and a diffraction light beam (for example, a +1 order diffraction light beam 41) diffracted by the plurality of movable mirror elements 3. “d” represents a period of the plurality of first movable mirror arrays 4 (i.e., a period of the plurality of second movable mirror arrays 5). “λ” represents the wavelength of the light beam 40 incident on the plurality of movable mirror elements 3. “m” represents an integer.

d×sin θ=mλ (1)

The diffraction grating formed by the movable mirrors 20 of the plurality of movable mirror elements 3 generates, for example, a +1 order diffraction light beam 41 and a −1 order diffraction light beam 42. The +1 order diffraction light beam 41 is a diffraction light beam having a diffraction order of +1. The −1 order diffraction light beam 42 is a diffraction light beam having a diffraction order of −1. The diffraction order of the diffraction light beam is equal to m.

The plurality of movable mirror elements 3 are capable of operating independently of each other. The controller 7 is capable of controlling the plurality of movable mirror elements 3 independently of each other. Therefore, the controller 7 can change the number of rows of the movable mirrors 20 included in each of the plurality of first movable mirror arrays 4 so as to change the period d of the plurality of first movable mirror arrays 4. The controller 7 can change the number of rows of the movable mirrors 20 included in each of the plurality of second movable mirror arrays 5 so as to change the period d of the plurality of second movable mirror arrays 5. Specifically, although in the example illustrated in FIG. 2, the number of rows of the movable mirrors 20 included in each of the plurality of first movable mirror arrays 4 is two, the number of rows of the movable mirrors 20 included in each of the plurality of first movable mirror arrays 4 may be changed to one or three or more. Although in the example illustrated in FIG. 2, the number of rows of the movable mirrors 20 included in each of the plurality of second movable mirror arrays 5 is two, the number of rows of the movable mirrors 20 included in each of the plurality of second movable mirror arrays 5 may be changed to one or three or more.

Changing the period d of the plurality of first movable mirror arrays 4 and the period d of the plurality of second movable mirror arrays 5 makes it possible to change the diffraction angle θ of the light beam diffracted by the plurality of movable mirror elements 3, that is, the deflection angle of the optical scanning device 1, which makes it possible to change an area to be optically scanned by the optical scanning device 1.

With reference to FIG. 7, an absolute value u of the difference between the first vertical displacement amount and the second vertical displacement amount may be given by the following equation (2). “λ” represents the wavelength of the light beam 40 incident on the plurality of movable mirror elements 3, and “n” represents zero or a natural number. Therefore, the light beam 40 can be prevented from being (perpendicularly) reflected toward the incident direction (the third direction (z direction)) of the light beam 40 in the diffraction grating formed by the plurality of movable mirror elements 3.

u=(¼+n/2)λ (2)

The plurality of movable mirror elements 3 are capable of operating independently of each other. The controller 7 can control the plurality of movable mirror elements 3 independently of each other. Therefore, as illustrated in FIGS. 2, 8 and 9, in the plan view of the main surface 2a of the substrate 2, the controller 7 can change the first longitudinal direction of each of the plurality of first movable mirror arrays 4 and the second longitudinal direction of each of the plurality of second movable mirror arrays 5 in a plane (a plane along the main surface 2a of the substrate 2, i.e., an xy plane) defined by the first direction (x direction) and the second direction (y direction). The light beam diffracted by the plurality of movable mirror elements 3 can be scanned around an axis (z axis) parallel to the third direction (z direction).

As illustrated in FIG. 7, the absolute value u may satisfy the following equation (3). “W” represents an interval between a pair of first movable mirror arrays 4 adjacent to each other among the plurality of first movable mirror arrays 4, and “0” represents a diffraction angle of a light beam diffracted by the plurality of movable mirror elements 3 (i.e., a deflection angle of the optical scanning device 1). Therefore, it is possible to block the diffraction light beam unnecessary for the optical scanning by using the first movable mirror array 4.

u≥W/tan θ (3)

As illustrated in FIG. 7, the optical scanning device 1 further includes a light shielding member 43 that blocks one of the +1 order diffraction light beam 41 and the −1 order diffraction light beam 42 generated by the diffraction grating. For example, if the −1 order diffraction light beam 42 is not used for the optical scanning, the light shielding member 43 blocks the −1 order diffraction light beam 42. The light shielding member 43 may be, for example, a light absorbing member.

The light shielding member 43 may be an optical shutter. Depending on the application of the optical scanning device 1, the −1 order diffraction light beam 42 may not be required as the light beam for the optical scanning, or both the −1 order diffraction light beam 42 and the +1 order diffraction light beam 41 may be required as the light beam for the optical scanning. When the −1 order diffraction light beam 42 is not required as the light beam for the optical scanning, the optical shutter blocks the −1 order diffraction light beam 42. When both the −1 order diffraction light beam 42 and the +1 order diffraction light beam 41 are required as the light beam for the optical scanning, the optical shutter allows the −1 order diffraction light beam 42 to pass therethrough.

The optical shutter may be, for example, a mechanical optical shutter or an electro-optical shutter. The electro-optical shutter is formed from, for example, a pair of polarizing plates and an electro-optical medium (for example, liquid crystal or lead lanthanum zirconate titanate (PLZT)) disposed between the pair of polarizing plates.

A method of manufacturing the optical scanning device 1 according to the first embodiment will be described with reference to FIGS. 3, 5, 6, and 10 to 16. The method of manufacturing the optical scanning device 1 according to the first embodiment includes a first step of forming a first structure including the substrate 2 and the beams 18a and 18b (see FIGS. 6 and 10 to 12), a second step of forming a second structure including the mirror film 22 and the pillar 23 (see FIGS. 13 and 14), and a third step of bonding the second structure to the first structure (see FIGS. 3, 5, 6, 15 and 16). The first step may be performed before the second step or after the second step.

The first step of forming a first structure including the substrate 2 and the beams 18a and 18b will be described with reference to FIGS. 6 and 10 to 12.

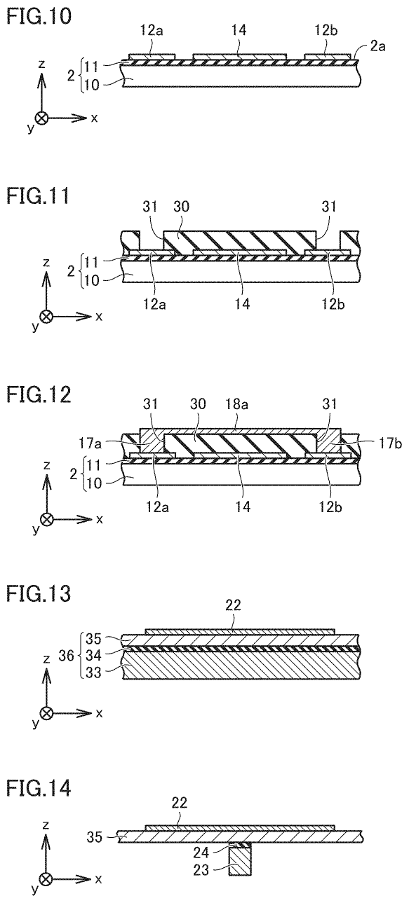

With reference to FIG. 10, the substrate 2 is prepared. In the present embodiment, the substrate 2 includes a conductive substrate 10 and a first insulating film 11 provided on the conductive substrate 10. The conductive substrate 10 is, for example, a silicon substrate containing a dopant. The first insulating film 11 is, for example, a silicon nitride film, a silicon dioxide film, or a laminated film of a silicon nitride film and a silicon dioxide film. The first insulating film 11 is formed on the conductive substrate 10 by plasma-enhanced chemical vapor deposition (PECVD), for example. The substrate 2 may be an insulating substrate.

As illustrated in FIGS. 6 and 10, the electrodes 12a, 12b, 12c, 12d and 14 and the wirings 13a, 13b, 13c, 13d and 15 are formed on the main surface 2a (or the first insulating film 11) of the substrate 2.

Specifically, a conductive film is formed on the main surface 2a (or the first insulating film 11) of the substrate 2. The conductive film is made of conductive polysilicon or a metal such as aluminum, gold or platinum. When the conductive film is made of conductive polysilicon, the conductive film is formed on the main surface 2a of the substrate 2 by, for example, a low pressure chemical vapor deposition (LPCVD) method. When the conductive film is made of a metal such as aluminum, gold or platinum, the conductive film is formed on the main surface 2a of the substrate 2 by, for example, a sputtering method. When the substrate 2 is an insulating substrate, the conductive film may be formed directly on the insulating substrate. The conductive substrate 10, the first insulating film 11 and the conductive film may constitute a silicon-on-insulator substrate (SOI substrate). When the conductive substrate 10, the first insulating film 11 and the conductive film constitute an SOI substrate, the conductive film is made of a conductive silicon film having a high dopant concentration.

Then, the conductive film is patterned to form the electrodes 12a, 12b, 12c, 12d and 14 and the wirings 13a, 13b, 13c, 13d and 15. Specifically, a resist (not shown) is formed on a part of the conductive film where the electrodes 12a, 12b, 12c, 12d and 14 and the wirings 13a, 13b, 13c, 13d and 15 are to be formed. The remaining part of the conductive film which is exposed from the resist is etched by a reactive ion etching (RIB) method such as an inductively coupled plasma reactive ion etching (ICP-RIE) method. The resist is removed by, for example, an oxygen ashing method.

As illustrated in FIG. 11, a sacrificial layer 30 is formed on the electrode 12a, 12b, 12c, 12d and 14, the wiring 13a, 13b, 13c, 13d and 15, and the main surface 2a of the substrate 2. The sacrificial layer 30 is made of, for example, phosphosilicate glass (PSG). The sacrificial layer 30 is formed by, for example, the LPCVD. The sacrificial layer 30 has a thickness of, for example, 0.01 μm or more and 20 μm or less.

As illustrated in FIG. 11, a hole 31 is formed in the sacrificial layer 30 by removing a portion of the sacrificial layer 30. The hole 31 is formed in a portion of the sacrificial layer 30 corresponding to each of the electrodes 12a, 12b, 12c and 12d. Each of the electrodes 12a, 12b, 12c and 12d in the corresponding hole 31 is exposed from the sacrificial layer 30. Specifically, a resist (not shown) is formed on the sacrificial layer 30. The resist is formed with holes (not shown). A part of the sacrificial layer 30 which is located in each hole of the resist and is exposed from the resist is removed by, for example, a dry etching method such as the RIE method or a wet etching method. The resist is removed by, for example, an oxygen ashing method.

As illustrated in FIGS. 6 and 12, the anchors 17a, 17b, 17c and 17d and the beams 18a and 18b are formed.

Specifically, a film is formed on the surface of the sacrificial layer 30 and in each hole 31 of the sacrificial layer 30. The film filled in each hole 31 of the sacrificial layer 30 corresponds to the anchor 17a, 17b, 17c and 17d, respectively. The film is made of, for example, a conductive material such as conductive polysilicon. When the film is made of conductive polysilicon, the film is formed by, for example, the LPCVD. In order to planarize the film, the film may be subjected to chemical mechanical polishing (CMP), for example. Then, the film formed on the surface of the sacrificial layer 30 is patterned to form the beams 18a and 18b. A part of the film is etched by an RIE method such as an ICP-RIE method. Thus, the first structure including the substrate 2 and the beams 18a and 18b is obtained.

The second step of forming the second structure including the mirror film 22 and the pillar 23 will be described with reference to FIGS. 13 and 14.

With reference to FIG. 13, a silicon-on-insulator substrate (an SOI substrate 36) is prepared. The SOI substrate 36 includes a silicon substrate 33, an insulating film 34 provided on the silicon substrate 33, and a silicon layer 35 provided on the insulating film 34. The silicon substrate 33 has a thickness of, for example, 10 μm or more and 1000 μm or less. The insulating film 34 has a thickness of, for example, 0.01 μm or more and 2.0 μm or less. The silicon layer 35 has a thickness of, for example, 1.0 μm or more and 100 μm or less. The silicon substrate 33 may be electrically conductive. The silicon layer 35 may be electrically conductive. The insulating film 34 is disposed between the silicon substrate 33 and the silicon layer 35 so as to electrically insulate the silicon substrate 33 from the silicon layer 35.

As illustrated in FIG. 13, the mirror film 22 is formed on the SOI substrate 36.

Specifically, a reflective film is formed on the SOI substrate 36. The reflective film is formed on the silicon layer 35 by a sputtering method, for example. The reflective film has a thickness of, for example, 0.01 μm or more and 1.0 μm or less. The reflective film is, for example, a Cr/Ni/Au film or a Ti/Pt/Au film. The Cr film and the Ti film improve adhesion of the mirror film 22 to the silicon layer 35. Since the uppermost layer of the reflective film is an Au film, the reflective film has a high reflectivity for the light beam incident on the optical scanning device 1. Then, the reflective film is patterned to form the mirror film 22. A portion of the reflective film is removed by, for example, a wet etching method, a lift-off method, or an ion beam etching method.

As illustrated in FIG. 14, a part of the silicon substrate 33 is removed to form the pillar 23. The part of the silicon substrate 33 may be removed by the ICP-RIE method, for example. A part of the insulating film 34 is removed to form the second insulating film 24. The part of the insulating film 34 may be removed by the ICP-RIE method, for example. Thus, the second structure including the mirror film 22 and the pillar 23 is obtained.

The third step of bonding the second structure to the first structure will be described with reference to FIGS. 3, 5, 6, 15 and 16.

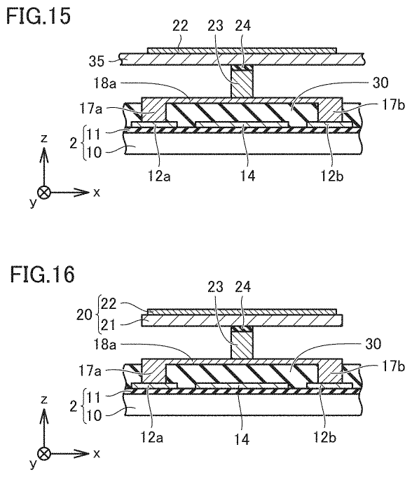

As illustrated in FIG. 15, the pillar 23 is bonded to the beams 18a and 18b. The pillar 23 is bonded to the beams 18a and 18b by, for example, a room temperature bonding method or a plasma surface activation bonding method. The pillar 23 is opposed to the electrode 14 in the third direction (z direction).

As illustrated in FIG. 16, a part of the silicon layer 35 is removed to form the movable plate 21. The part of the silicon layer 35 may be removed by the ICP-RIE method, for example.

Then, the sacrificial layer 30 is removed by a wet etching method or a dry etching method using hydrofluoric acid or the like. Thus, the optical scanning device 1 illustrated in FIGS. 3, 5 and 6 is obtained.

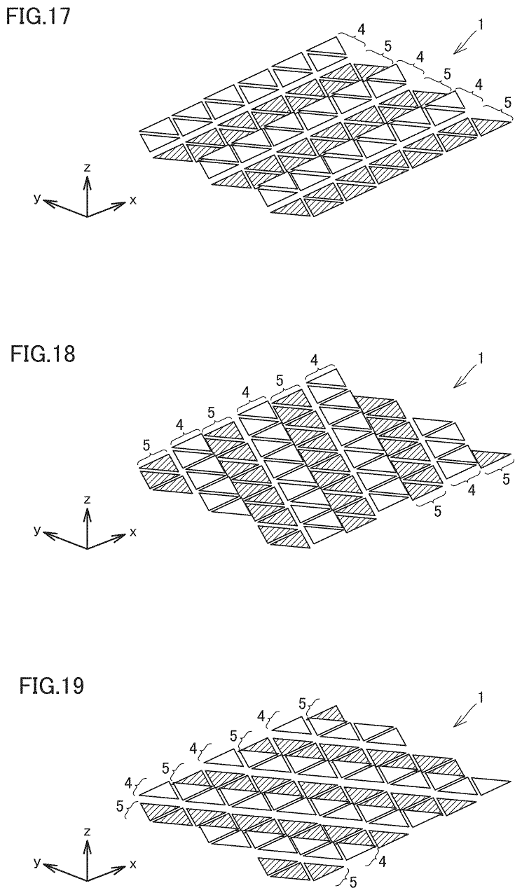

A modification of the present embodiment will be described with reference to FIGS. 17 to 19. In the modification of the present embodiment, the movable mirror 20 has a regular triangular shape in a plan view of the main surface 2a of the substrate 2. Therefore, it is easy to perform an optical scanning with a light beam in a plurality of directions different from each other by 60° in a plane (a plane along the main surface 2a of the substrate 2, i.e., an xy plane) defined by the first direction (x direction) and the second direction (y direction). In the plan view of the main surface 2a of the substrate 2, the movable mirror 20 may have a regular hexagon shape or a regular octagon shape.

Effects of the optical scanning device 1 of the present embodiment will be described.

The optical scanning device 1 of the present embodiment includes a substrate 2 and a plurality of movable mirror elements 3. The substrate 2 includes a main surface 2a that extends in a first direction (x direction) and a second direction (y direction) perpendicular to the first direction (x direction). The plurality of movable mirror elements 3 are two-dimensionally arranged on the main surface 2a of the substrate 2 in a plan view of the main surface 2a of the substrate 2. The plurality of movable mirror elements 3 are capable of operating independently of each other and capable of forming a diffraction grating. Each of the plurality of movable mirror elements 3 includes a beam (for example, a beam 18a), a first anchor (for example, an anchor 17a), a second anchor (for example, an anchor 17a), a movable mirror 20, and a pillar 23. The beam is bendable in a third direction (z direction) perpendicular to the main surface 2a of the substrate 2. The first anchor is provided on the main surface 2a of the substrate 2 to support the first end of the beam. The second anchor is provided on the main surface 2a of the substrate 2 to support the second end of the beam opposite to the first end. The movable mirror 20 includes a movable plate 21 separated from the beam in the third direction (z direction), and a mirror film 22 provided on the movable plate 21. The pillar 23 connects the movable plate 21 to a portion of the beam other than the first end and the second end to each other.

In the optical scanning device 1, the light beam 40 incident on the optical scanning device 1 is received by the movable mirrors 20 of the plurality of movable mirror elements 3. Thus, it is possible to reduce the size and mass of each movable mirror 20, which makes it possible to move each movable mirror 20 at a higher speed. Therefore, it is possible for the optical scanning device 1 to perform an optical scanning with a light beam at a higher speed. Further, in the optical scanning device 1, the light beam 40 incident on the optical scanning device 1 is deflected by a diffraction grating formed from a plurality of movable mirror elements 3 capable of operating independently of each other. Therefore, it is possible for the optical scanning device 1 to perform an optical scanning with a light beam at a larger deflection angle.

Since the beam (for example, the beam 18a) is bendable in the third direction (z direction) perpendicular to the main surface 2a of the substrate 2, it is possible for the movable mirror 20 connected to the beam to move in the third direction (z direction). Therefore, it is possible to move the movable mirror 20 without twisting the beam, which makes it possible to prevent torsional rupture of the beam when the movable mirror 20 is driven to move. Therefore, the optical scanning device 1 has a longer lifetime. Further, according to the optical scanning device 1, it is possible to perform an optical scanning with a light beam at a larger deflection angle without setting the driving frequency of the movable mirror 20 to the resonance frequency of the movable mirror 20. Therefore, the optical scanning device 1 can perform an optical scanning with a light beam at a larger deflection angle more stably regardless of the driving frequency of the movable mirror 20.

The optical scanning device 1 according to the present embodiment further includes a controller 7 that controls a vertical displacement amount of the movable mirror 20 in the third direction (z direction). The controller 7 constructs a plurality of first movable mirror arrays 4 and a plurality of second movable mirror arrays 5 from the plurality of movable mirror elements 3. The plurality of first movable mirror arrays 4 are constructed from a part of the plurality of movable mirror elements 3 in which the vertical displacement amount of the movable mirror 20 is a first vertical displacement amount. The plurality of second movable mirror arrays 5 are constructed from the remaining part of the plurality of movable mirror elements 3 in which the vertical displacement amount of the movable mirror 20 is a second vertical displacement amount which is larger than the first vertical displacement amount. In the plan view of the main surface 2a of the substrate 2, the first longitudinal direction of each of the plurality of first movable mirror arrays 4 is parallel to the second longitudinal direction of each of the plurality of second movable mirror arrays 5. The plurality of first movable mirror arrays 4 and the plurality of second movable mirror arrays 5 are arranged alternately and periodically in a direction perpendicular to the first longitudinal direction. In the plan view of the main surface 2a of the substrate 2, the controller 7 is capable of changing the first longitudinal direction and the second longitudinal direction.

Therefore, it is possible for the optical scanning device 1 to perform an optical scanning with a light beam around an axis parallel to the third direction (z direction) at a higher speed.

In the optical scanning device 1 of the present embodiment, the absolute value u of the difference between the first vertical displacement amount and the second vertical displacement amount is given by the following equation (4). “λ” represents the wavelength of the light beam incident on the plurality of movable mirror elements 3, and “n” represents zero or a natural number.

u=(¼+n/2)λ (4)

Therefore, the light beam 40 be prevented from being (perpendicularly) reflected toward the incident direction (the third direction (z direction)) of the light beam 40 by the diffraction grating formed from the plurality of movable mirror elements 3.

In the optical scanning device 1 of the present embodiment, the absolute value u satisfies the following equation (5). “W” represents an interval between a pair of first movable mirror arrays 4 adjacent to each other among the plurality of first movable mirror arrays 4, and “θ” represents a diffraction angle of a light beam diffracted by the plurality of movable mirror elements 3.

u≥W/tan θ (5)

Therefore, it is possible to block the diffraction light beam that is not required for the optical scanning by using the first movable mirror array 4.

The optical scanning device 1 of the present embodiment further includes a light shielding member 43 that blocks one of a pair of diffraction light beams generated by the diffraction grating. Therefore, it is possible to block the diffraction light beam that is not required for the optical scanning.

In the optical scanning device 1 of the present embodiment, the light shielding member 43 is an optical shutter. Therefore, one of the pair of diffraction beam beams is blocked or transmitted depending on the application of the optical scanning device 1. It is possible to expand the application of the optical scanning device 1.

In the optical scanning device 1 of the present embodiment, the beam (for example, the beam 18a) is electrically conductive. Each of the plurality of movable mirror elements 3 includes a first electrode (for example, the electrode 12a) and a second electrode (for example, the electrode 12b). The first electrode and the second electrode are provided on the main surface 2a of the substrate 2, and are electrically insulated from each other. The first electrode is electrically connected to the beam. The second electrode is opposed to the pillar 23 and a portion of the beam in the third direction (z direction).

Therefore, the beam (for example, the beam 18a) is driven in accordance with a voltage applied between the first electrode (for example, the electrode 12a) and the second electrode (for example, the electrode 12b), which makes it possible for the optical scanning device 1 to perform an optical scanning with a light beam at a higher speed and a larger deflection angle.

### Second Embodiment

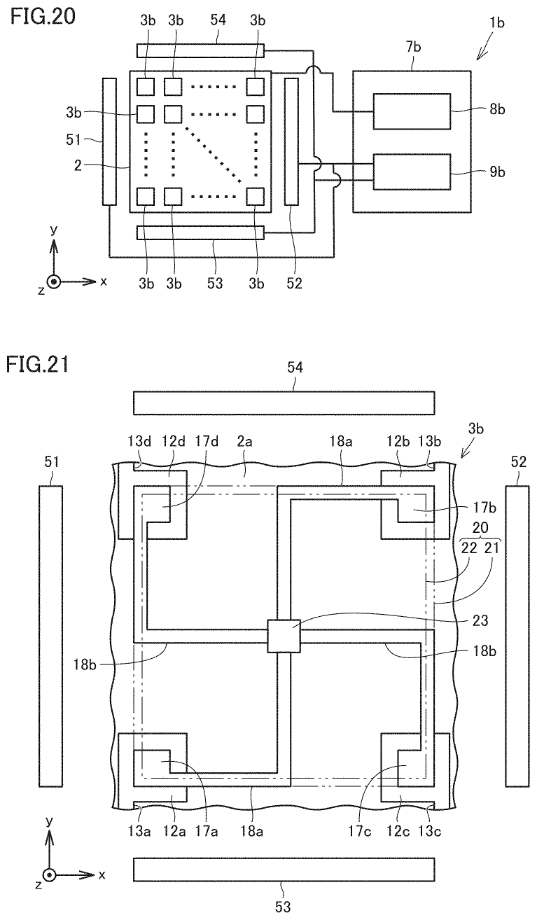

An optical scanning device 1b according to a second embodiment will be described with reference to FIGS. 20 and 21. The optical scanning device 1b of the present embodiment has substantially the same configuration as the optical scanning device 1 of the first embodiment, but is different from the optical scanning device 1 of the first embodiment mainly on the following points.

The optical scanning device 1b further includes magnets 51 and 52. The magnets 51 and 52 are, for example, permanent magnets or electromagnets. The magnets 51 and 52 are provided on both sides of the substrate 2 in the first direction (x direction). The substrate 2 is sandwiched between the magnet 51 and the magnet 52 in the first direction (x direction). The magnets 51 and 52 generate a magnetic field along the main surface 2a of the substrate 2 on the beam 18a. Specifically, the magnets 51 and 52 generate a magnetic field in the direction (the first direction (x direction)) along the main surface 2a of the substrate 2 which is perpendicular to the longitudinal direction (the second direction (y direction)) of the beam 18a on a portion of the beam 18a connected to the pillar 23.

The optical scanning device 1b may further include magnets 53 and 54. The magnets 53 and 54 are, for example, permanent magnets or electromagnets. The magnets 53 and 54 are provided on both sides of the substrate 2 in the second direction (y direction). The substrate 2 is sandwiched between the magnet 53 and the magnet 54 in the second direction (y direction). The magnets 53 and 54 generate a magnetic field along the main surface 2a of the substrate 2 on the beam 18b. Specifically, the magnets 53 and 54 generate a magnetic field in the direction (the second direction (y direction)) along the main surface 2a of the substrate 2 which is perpendicular to the longitudinal direction (the first direction (x direction)) of the beam 18b on a portion of the beam 18b connected to the pillar 23.

With reference to FIG. 21, the wiring 13a is connected to the electrode 12a, and is configured to supply a current to the electrode 12a. The wiring 13b is connected to the electrode 12b, and is configured to supply a current to the electrode 12b. The wiring 13c is connected to the electrode 12c, and is configured to supply a current to the electrode 12c. The wiring 13d is connected to the electrode 12d, and is configured to supply a current to the electrode 12d. Different from the plurality of movable mirror elements 3 of the first embodiment, the plurality of movable mirror elements 3b of the present embodiment do not include the electrode 14 and the wiring 15.

As illustrated in FIG. 20, the controller 7b includes at least one of a current control unit 8b or a magnetic field control unit 9b.

The current control unit 8b is connected to the electrode 12a and the electrode 12b via the wiring 13a and the wiring 13b. The current control unit 8b is connected to the electrode 12c and the electrode 12d via the wirings 13c and 13d. The electrode 12a is electrically connected to the first end of the beam 18a via the anchor 17a. The electrode 12b is electrically connected to the second end of the beam 18a opposite to the first end of the beam 18a via the anchor 17b. The electrode 12c is electrically connected to the third end of the beam 18b via the anchor 17c. The electrode 12d is electrically connected to the fourth end of the beam 18b opposite to the third end of the beam 18b via the anchor 17d. The beams 18a and 18b are electrically conductive. The current control unit 8b controls a current flowing through the beam 18a electrically connected to the electrode 12a and the electrode 12b. The current control unit 8b controls a current flowing through the beam 18b electrically connected to the electrode 12c and the electrode 12d.

When the magnets 51 and 52 are electromagnets, the magnetic field control unit 9b controls the magnets 51 and 52 so as to control the magnetic field to be formed by the magnets 51 and 52 on the beam 18a. When the magnets 53 and 54 are electromagnets, the magnetic field control unit 9b controls the magnets 53 and 54 so as to control the magnetic field generated by the magnets 53 and 54 on the beam 18b. Thus, the controller 7b can control the vertical displacement amount of the movable mirror 20 in the third direction (z direction).

As a first example, when the magnets 51 and 52 are permanent electromagnets, the current control unit 8b supplies a zero current to the beam 18a. No Lorentz force acts on the beam 18a. The beam 18a is not bent, and thereby the first vertical displacement amount of the movable mirror 20 is zero. Thus, it is possible to realize the movable mirror elements 3b in which the vertical displacement amount of the movable mirror 20 is the first vertical displacement amount. On the other hand, when the current control unit 8b supplies a non-zero current to the beam 18a, a Lorentz force acts on the beam 18a. The beam 18a is bent toward the main surface 2a of the substrate 2, and the second vertical displacement amount of the movable mirror 20 is larger than the first vertical displacement amount. Thus, it is possible to realize the movable mirror elements 3b in which the vertical displacement amount of the movable mirror 20 is the second vertical displacement amount. Those described above with respect to the beam 18a also applies to the beam 18b.

As a second example, when the magnets 51 and 52 are electromagnets, the current control unit 8b supplies a current to the beam 18a, and the magnetic field control unit 9b turns off the magnets 51 and 52. Since no magnetic field is generated by the magnets 51 and 52 on the beam 18a, no Lorentz force acts on the beam 18a. The beam 18a is not bent, and thereby the first vertical displacement amount of the movable mirror 20 is zero. Thus, it is possible to realize the movable mirror elements 3b in which the vertical displacement amount of the movable mirror 20 is the first vertical displacement amount. On the other hand, the current control unit 8b supplies a current to the beam 18a, and the magnetic field control unit 9b turns on the magnets 51 and 52. Since a magnetic field is generated by the magnets 51 and 52 on the beam 18a, a Lorentz force acts on the beam 18a. The beam 18a is bent toward the main surface 2a of the substrate 2, and thereby the second vertical displacement amount of the movable mirror 20 is larger than the first vertical displacement amount. Thus, it is possible to realize the movable mirror elements 3b in which the vertical displacement amount of the movable mirror 20 is the second vertical displacement amount. Those described above with respect to the beam 18a also applies to the beam 18b.

The optical scanning device 1b according to the present embodiment has the following effects in addition to the effects of the optical scanning device 1 according to the first embodiment.

The optical scanning device 1b of the present embodiment further includes a first magnet (for example, at least one of the magnets 51 and 52) that generates a first magnetic field along the main surface 2a of the substrate 2 on a beam (for example, the beam 18a). The beam is electrically conductive. Each of the plurality of movable mirror elements 3b includes a first electrode (for example, the electrode 12a) and a second electrode (for example, the electrode 12b). The first electrode and the second electrode are provided on the main surface 2a of the substrate 2, and are separated from each other. The first electrode is electrically connected to the first end of the beam. The second electrode is electrically connected to the second end of the beam.

Therefore, the beam is driven in accordance with the current flowing through the beam (for example, the beam 18a) and the first magnetic field formed on the beam by the first magnet (for example, at least one of the magnets 51 and 52), which makes it possible for the optical scanning device 1b to perform an optical scanning with a light beam at a higher speed and a larger deflection angle.

### Third Embodiment

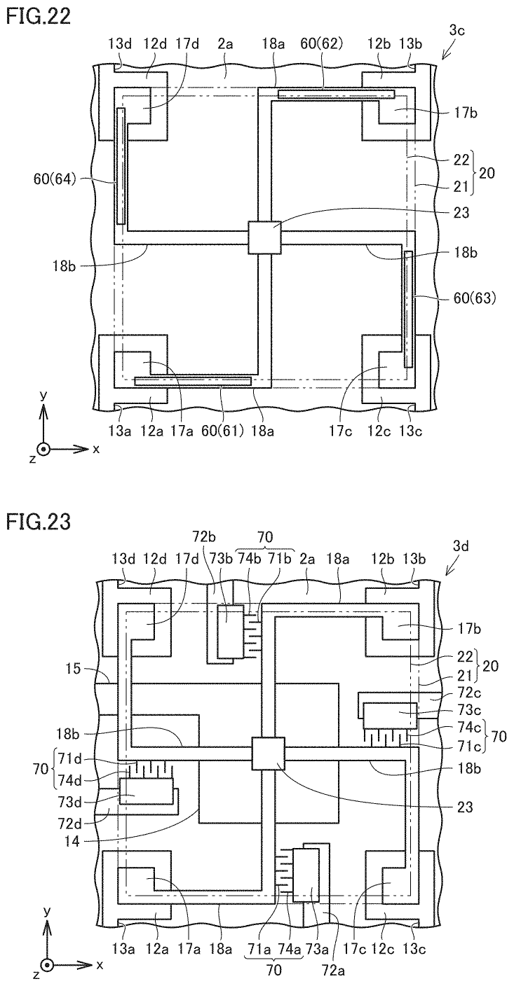

An optical scanning device 1c according to a third embodiment will be described with reference to FIGS. 1 and 22. The optical scanning device 1c of the present embodiment has substantially the same configuration as the optical scanning device 1 of the first embodiment, but is different from the optical scanning device 1 of the first embodiment mainly on the following points.

The plurality of movable mirror elements 3c include piezoelectric films 61 and 62. The plurality of movable mirror elements 3c may further include piezoelectric films 63 and 64. The piezoelectric films 61, 62, 63, 64 are made of, for example, lead zirconate titanate (PZT), barium titanate (BaTiO₃), lead titanate (PbTiO₃), or zinc oxide (ZnO).

The piezoelectric films 61 and 62 are provided on the beam 18a. Specifically, the piezoelectric films 61 and 62 are provided on a front surface of the beam 18a opposite to a back surface of the beam 18a opposed to the main surface 2a of the substrate 2. The piezoelectric film 61 is provided on a portion of the beam 18a that is located closer to the electrode 12a or the anchor 17a than a portion of the beam 18a (for example, a central portion of the beam 18a) connected to the pillar 23. The piezoelectric film 62 is provided on a portion of the beam 18a that is located closer to the electrode 12b or the anchor 17b than a portion of the beam 18a (for example, a central portion of the beam 18a) connected to the pillar 23. The piezoelectric film 63 is provided on a portion of the beam 18b that is located closer to the electrode 12c or the anchor 17c than a portion of the beam 18b (for example, a central portion of the beam 18b) connected to the pillar 23. The piezoelectric film 64 is provided on a portion of the beam 18b that is located closer to the electrode 12d or the anchor 17d than a portion of the beam 18b (for example, a central portion of the beam 18b) connected to the pillar 23.

Different from the plurality of movable mirror elements 3c of the first embodiment, the plurality of movable mirror elements 3c of the present embodiment do not include the electrode 14 and the wiring 15.

The controller 7c includes a voltage control unit 8c. The voltage control unit 8c is connected to the electrode 12a and the electrode 12b via the wiring 13a and the wiring 13b. The voltage control unit 8c is connected to the electrode 12c and the electrode 12d via the wirings 13c and 13d. The piezoelectric film 61 is electrically connected to the electrode 12a via the anchor 17a and the beam 18a. The piezoelectric film 62 is electrically connected to the electrode 12b via the anchor 17b and the beam 18a. The piezoelectric film 63 is electrically connected to the electrode 12c via the anchor 17c and the beam 18b. The piezoelectric film 64 is electrically connected to the electrode 12d via the anchor 17d and the beam 18b.

The voltage control unit 8c controls the voltage of the piezoelectric film 61 electrically connected to the electrode 12a. The voltage control unit 8c controls the voltage of the piezoelectric film 62 electrically connected to the electrode 12b. The voltage control unit 8c controls the voltage of the piezoelectric film 63 electrically connected to the electrode 12c. The voltage control unit 8c controls the voltage of the piezoelectric film 64 electrically connected to the electrode 12d. Thus, the controller 7c can control the vertical displacement amount of the movable mirror 20 in the third direction (z direction).

For example, the voltage control unit 8c applies a zero voltage to the piezoelectric films 61 and 62. The beam 18a is not bent, and thereby the first vertical displacement amount of the movable mirror 20 is zero. Thus, it is possible to realize the movable mirror elements 3c in which the vertical displacement amount of the movable mirror 20 is the first vertical displacement amount. On the other hand, the voltage control unit 8c applies a non-zero voltage to the piezoelectric films 61 and 62. The beam 18a is bent toward the main surface 2a of the substrate 2, and thereby the second vertical displacement amount of the movable mirror 20 is larger than the first vertical displacement amount. Those described above with respect to the beam 18a also applies to the beam 18b. Thus, it is possible to realize the movable mirror elements 3c in which the vertical displacement amount of the movable mirror 20 is the second vertical displacement amount.

The optical scanning device 1c according to the present embodiment has the following effects in addition to the effects of the optical scanning device 1 according to the first embodiment.

In the optical scanning device 1c of the present embodiment, the plurality of movable mirror elements 3c include a piezoelectric film (for example, at least one of the piezoelectric films 61 and 62) provided on a beam (for example, the beam 18a). Therefore, the beam is driven in accordance with the voltage applied to the piezoelectric film, which makes it possible for the optical scanning device 1c to perform an optical scanning with a light beam at a higher speed and a larger deflection angle.

### Fourth Embodiment

An optical scanning device 1d according to a fourth embodiment will be described with reference to FIGS. 1 and 23. The optical scanning device 1d of the present embodiment has substantially the same configuration as the optical scanning device 1 of the first embodiment, but is different from the optical scanning device 1 of the first embodiment mainly on the following points.

The optical scanning device 1d further includes an in-plane driving unit 70 that drives the beams 18a and 18b to move in at least one direction of the first direction (x direction) or the second direction (y direction). The in-plane driving unit 70 includes comb-shaped electrodes 71a and 71b and comb-shaped electrodes 74a and 74b.

Each of the plurality of movable mirror elements 3d includes comb-shaped electrodes 71a and 71b, wirings 72a and 72b, driving electrodes 73a and 73b, and comb-shaped electrodes 74a and 74b. The wirings 72a and 72b are provided on the main surface 2a of the substrate 2. The wirings 72a and 72b are made of, for example, the same material as the wiring 13a, 13b, 13c, 13d or 15. The wirings 72a and 72b are formed by the same step as the step of forming the wiring 13a, 13b, 13c, 13d or 15, for example.

The driving electrode 73a is provided on the main surface 2a of the substrate 2 via the wiring 72a. The driving electrode 73a may be made of the same material as the anchor 17a, for example. The driving electrode 73b is provided on the main surface 2a of the substrate 2 via the wiring 72b. The driving electrodes 73a and 73b may be made of the same material as the anchor 17b, for example. The driving electrodes 73a and 73b are formed by the same step as the step of forming the anchors 17a and 17b, for example.

The comb-shaped electrode 74a is provided on the driving electrode 73a. The comb-shaped electrode 74a protrudes in the first direction (x direction) from a side surface of the driving electrode 73a. The comb-shaped electrode 74b is provided on the driving electrode 73b. The comb-shaped electrode 74b protrudes in the first direction (x direction) from a side surface of the driving electrode 73b. The comb-shaped electrodes 74a and 74b are made of the same material as the beam 18a, for example. The comb-shaped electrodes 74a and 74b are formed by the same step as the step of forming the beam 18a, for example. The comb-shaped electrodes 74a and 74b function as fixed comb-shaped electrodes.

The comb-shaped electrode 71a is provided on the beam 18a. Specifically, the comb-shaped electrode 71a is provided on a portion of the beam 18a that is located closer to the electrode 12a or the anchor 17a than a portion of the beam 18a (for example, a central portion of the beam 18a) connected to the pillar 23. The comb-shaped electrode 71a protrudes in the first direction (x direction) from a first side surface of the beam 18a. The comb-shaped electrode 71b is provided on the beam 18a. Specifically, the comb-shaped electrode 71b is provided on a portion of the beam 18a that is located closer to the electrode 12b or the anchor 17b than the portion of the beam 18a (for example, the central portion of the beam 18a) connected to the pillar 23. The comb-shaped electrode 71b protrudes in the first direction (x direction) from a second side surface of the beam 18a opposite to the first side surface of the beam 18a. The comb-shaped electrodes 71a and 71b are made of the same material as the beam 18a, for example. The comb-shaped electrodes 71a and 71b are formed by the same step as the step of forming the beam 18a, for example. The comb-shaped electrodes 71a and 71b function as movable comb-shaped electrodes.

The comb-shaped electrode 71a and the comb-shaped electrode 74a are opposed to each other. The comb-shaped electrode 71b and the comb-shaped electrode 74b are opposed to each other.

The in-plane driving unit 70 may further include comb-shaped electrodes 71c and 71d and comb-shaped electrodes 74c and 74d.

Each of the plurality of movable mirror elements 3d further includes comb-shaped electrodes 71c and 71d, wirings 72c and 72d, driving electrodes 73c and 73d, and comb-shaped electrodes 74c and 74d. The wirings 72c and 72d are provided on the main surface 2a of the substrate 2. The wirings 72c and 72d are made of, for example, the same material as the wiring 13a, 13b, 13c, 13d and 15. The wirings 72c and 72d are formed by the same step as the step of forming the wiring 13a, 13b, 13c, 13d and 15, for example.

The driving electrode 73c is provided on the main surface 2a of the substrate 2 via the wiring 72c. The driving electrode 73c may be made of the same material as the anchor 17c, for example. The driving electrode 73d is provided on the main surface 2a of the substrate 2 via the wiring 72d. The driving electrodes 73c and 73d may be made of the same material as the anchor 17d, for example. The driving electrodes 73c and 73d are formed by the same step as the step of forming the anchors 17c and 17d, for example.

The comb-shaped electrode 74c is provided on the driving electrode 73c. The comb-shaped electrode 74c protrudes in the second direction (y direction) from a side surface of the driving electrode 73c. The comb-shaped electrode 74d is provided on the driving electrode 73d. The comb-shaped electrode 74d protrudes in the second direction (y direction) from a side surface of the driving electrode 73d. The comb-shaped electrodes 74c and 74d are made of the same material as the beam 18b, for example. The comb-shaped electrodes 74c and 74d are formed by the same step as the step of forming the beam 18b, for example. The comb-shaped electrodes 74c and 74d function as fixed comb-shaped electrodes.

The comb-shaped electrode 71c is provided on the beam 18b. Specifically, the comb-shaped electrode 71c is provided on a portion of the beam 18b that is located closer to the electrode 12c or the anchor 17c than a portion of the beam 18b (for example, a central portion of the beam 18b) connected to the pillar 23. The comb-shaped electrode 71c protrudes in the second direction (y direction) from a third side surface of the beam 18b. The comb-shaped electrode 71d is provided on the beam 18b. Specifically, the comb-shaped electrode 71d is provided on a portion of the beam 18b that is located closer to the electrode 12d or the anchor 17d than the portion of the beam 18b (for example, the central portion of the beam 18b) connected to the pillar 23. The comb-shaped electrode 71d protrudes in the second direction (y direction) from a fourth side surface of the beam 18b opposite to the third side surface of the beam 18b. The comb-shaped electrodes 71c and 71d are made of the same material as the beam 18b, for example. The comb-shaped electrodes 71c and 71d are formed by the same step as the step of forming the beam 18b, for example. The comb-shaped electrodes 71c and 71d function as movable comb-shaped electrodes.

The comb-shaped electrode 71c and the comb-shaped electrode 74c are opposed to each other. The comb-shaped electrode 71d and the comb-shaped electrode 74d are opposed to each other.

The controller 7d includes a voltage control unit 8d. The voltage control unit 8d of the present embodiment is similar to the voltage control unit 8 of the first embodiment, but is different from the voltage control unit 8 of the first embodiment on the following points.

The voltage controller 8d further controls the voltage of the beam 18a. The beam 18a is electrically conductive. Therefore, the voltage control unit 8d further controls the voltages of the comb-shaped electrodes 71a and 71b provided on the beam 18a. The voltage controller 8d further controls the voltage of the beam 18b. The beam 18b is electrically conductive. Therefore, the voltage control unit 8d further controls the voltages of the comb-shaped electrodes 71c and 71d provided on the beam 18b.

The voltage control unit 8d is connected to the driving electrode 73a via the wiring 72a. Therefore, the voltage control unit 8d further controls the voltage of the comb-shaped electrode 74a. The voltage control unit 8d is connected to the driving electrode 73b via the wiring 72b. Therefore, the voltage control unit 8d further controls the voltage of the comb-shaped electrode 74b. The voltage control unit 8d is connected to the driving electrode 73c via the wiring 72c. Therefore, the voltage control unit 8d further controls the voltage of the comb-shaped electrode 74c. The voltage control unit 8d is connected to the driving electrode 73d via the wiring 72d. Therefore, the voltage control unit 8d further controls the voltage of the comb-shaped electrode 74d.

The voltage control unit 8d controls the voltage between the comb-shaped electrodes 71a and 74a. The voltage control unit 8d controls the voltage between the comb-shaped electrodes 71b and 74b. The voltage control unit 8d controls the voltage between the comb-shaped electrodes 71c and 74c. The voltage control unit 8d controls the voltage between the comb-shaped electrodes 71d and 74d. Thus, the controller 7d can control the horizontal displacement amount of the movable mirror 20 in the first direction (x direction) or the second direction (y direction).

For example, when the movable mirrors 20 of the plurality of movable mirror elements 3d are arranged as illustrated in FIGS. 2 and 7, the diffraction angle θ can be changed by changing the period of the plurality of first movable mirror arrays 4 and the period of the plurality of second movable mirror arrays 5 in the first direction (x direction).

Specifically, the voltage control unit 8d controls the voltage between the comb-shaped electrode 71a and the comb-shaped electrode 74a to generate an electrostatic attractive force between the comb-shaped electrode 71a and the comb-shaped electrode 74a, which causes the movable mirror 20 to move in the positive first direction (+x direction) together with the beam 18a. On the other hand, the voltage control unit 8d controls the voltage between the comb-shaped electrode 71b and the comb-shaped electrode 74b to generate an electrostatic attractive force between the comb-shaped electrode 71b and the comb-shaped electrode 74b, which causes the movable mirror 20 to move in the negative first direction (−x direction) together with the beam 18a.

The movement amount of each movable mirror 20 in the first direction (x direction) is changed for each movable mirror 20. Thus, the period of the plurality of first movable mirror arrays 4 and the period of the plurality of second movable mirror arrays 5 in the first direction (x direction) can be changed. For example, when the period of the plurality of first movable mirror arrays 4 and the period of the plurality of second movable mirror arrays 5 in the first direction (x direction) are made smaller, the diffraction angle θ becomes larger. When the period of the plurality of first movable mirror arrays 4 and the period of the plurality of second movable mirror arrays 5 in the first direction (x direction) are made larger, the diffraction angle θ becomes smaller. Those described above with respect to the beam 18a also applies to the beam 18b.

When the movable mirrors 20 of the plurality of movable mirror elements 3d are arranged as illustrated in FIG. 9, the diffraction angle θ can be changed by changing the period of the plurality of second movable mirror arrays 5 and the period of the plurality of second movable mirror arrays 5 in the second direction (y direction).

Specifically, the voltage control unit 8d controls the voltage between the comb-shaped electrode 71c and the comb-shaped electrode 74c to generate an electrostatic attractive force between the comb-shaped electrode 71c and the comb-shaped electrode 74c, which causes the movable mirror 20 to move in the positive second direction (+y direction) together with the beam 18b. On the other hand, the voltage control unit 8d controls the voltage between the comb-shaped electrode 71d and the comb-shaped electrode 74d to generate an electrostatic attractive force between the comb-shaped electrode 71d and the comb-shaped electrode 74d, which causes the movable mirror 20 to move in the negative second direction (−y direction) together with the beam 18b.

The movement amount of each movable mirror 20 in the second direction (y direction) is changed for each movable mirror 20. Thus, the period of the plurality of first movable mirror arrays 4 and the period of the plurality of second movable mirror arrays 5 in the second direction (y direction) can be changed. For example, when the period of the plurality of first movable mirror arrays 4 and the period of the plurality of second movable mirror arrays 5 in the second direction (y direction) are made smaller, the diffraction angle θ becomes larger. When the period of the plurality of first movable mirror arrays 4 and the period of the plurality of second movable mirror arrays 5 in the second direction (y direction) are made larger, the diffraction angle θ becomes smaller. Those described above with respect to the beam 18a also applies to the beam 18b.

The optical scanning device 1d according to the present embodiment has the following effects in addition to the effects of the optical scanning device 1 according to the first embodiment.

The optical scanning device 1d of the present embodiment further includes an in-plane driving unit 70 that drives the beam (for example, the beam 18a) to move in at least one direction of the first direction (x direction) or the second direction (y direction). Therefore, it is possible to change the deflection angle of the optical scanning device 1d, which makes it possible for the optical scanning device 1d to change the area to be optically scanned.

In the optical scanning device 1d of the present embodiment, the beam (for example, the beam 18a) is electrically conductive. The in-plane driving unit 70 includes a first comb-shaped electrode (for example, the comb-shaped electrode 71a) provided on the beam, a driving electrode (for example, the driving electrode 73a) provided on the main surface 2a of the substrate 2, and a second comb-shaped electrode (for example, the comb-shaped electrode 74a) provided on the driving electrode. The first comb-shaped electrode and the second comb-shaped electrode are opposed to each other.

Therefore, it is possible to change the deflection angle of the optical scanning device 1d in accordance with the voltage applied between the first comb-shaped electrode and the second comb-shaped electrode, which makes it possible for the optical scanning device 1d to change the area to be optically scanned.

### Fifth Embodiment

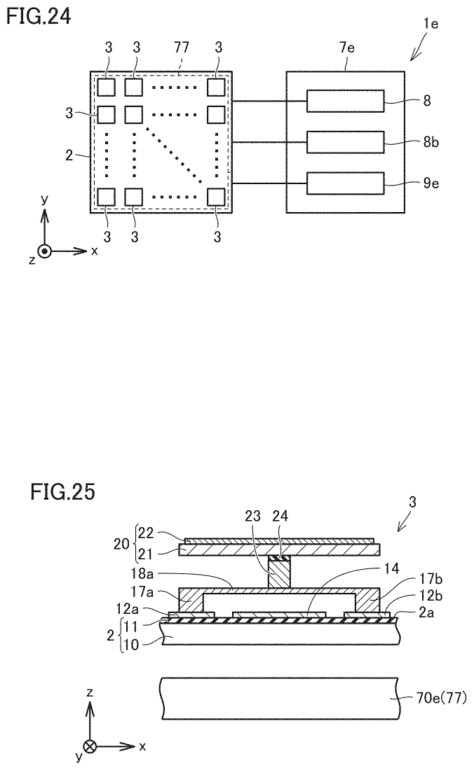

With reference to FIGS. 24 and 25, an optical scanning device 1e according to a fifth embodiment will be described. The optical scanning device 1e of the present embodiment has substantially the same configuration as the optical scanning device 1 of the first embodiment, but is different from the optical scanning device 1 of the first embodiment mainly on the following points.

The optical scanning device 1e further includes an in-plane driving unit 70e that drives the beams 18a and 18b to move in at least one direction of the first direction (x direction) or the second direction (y direction). The in-plane driving unit 70e includes a magnet 77. The magnet 77 is, for example, a permanent magnet or an electromagnet. The magnet 77 is provided on a side distal to the movable mirror 20 with respect to the substrate 2. The magnet 77 generates a magnetic field perpendicular to the main surface 2a of the substrate 2 on the beams 18a and 18b. The magnet 77 generates a magnetic field along the third direction (z direction) on the beams 18a and 18b.

The wiring 13a is connected to the electrode 12a, and is configured to supply a voltage and a current to the electrode 12a. The wiring 13b is connected to the electrode 12b, and is configured to supply a voltage and a current to the electrode 12b. The wiring 13c is connected to the electrode 12c, and is configured to supply a voltage and a current to the electrode 12c. The wiring 13d is connected to the electrode 12d, and is configured to supply a voltage and a current to the electrode 12d.

The electrode 12a is electrically connected to the first end of the beam 18a via the anchor 17a. The electrode 12b is electrically connected to the second end of the beam 18a opposite to the first end of the beam 18a via the anchor 17b. The electrode 12c is electrically connected to the third end of the beam 18b via the anchor 17c. The electrode 12d is electrically connected to the fourth end of the beam 18b opposite to the third end of the beam 18b via the anchor 17d.

As illustrated in FIG. 24, the controller 7e includes a voltage controller 8, and at least one of a current control unit 8b or a magnetic field control unit 9e.

The current control unit 8b of the present embodiment is the same as the current control unit 8b of the second embodiment. The current control unit 8b is connected to the electrode 12a and the electrode 12b via the wiring 13a and the wiring 13b. The current control unit 8b is connected to the electrode 12c and the electrode 12d via the wirings 13c and 13d. The current control unit 8b controls a current flowing through the beam 18a connected to the electrode 12a and the electrode 12b. The current control unit 8b controls a current flowing through the beam 18b connected to the electrode 12c and the electrode 12d. The beams 18a and 18b are electrically conductive.

When the magnet 77 is an electromagnet, the magnetic field control unit 9e controls the magnet 77 to control the magnetic field generated by the magnet 77 on the beams 18a and 18b. Thus, the controller 7e can control the horizontal displacement amount of the movable mirror 20 in the first direction (x direction) or the second direction (y direction).

For example, when the movable mirrors 20 of the plurality of movable mirror elements 3d are arranged as illustrated in FIGS. 2 and 7, the diffraction angle θ can be changed by changing the period of the plurality of first movable mirror arrays 4 and the period of the plurality of second movable mirror arrays 5 in the first direction (x direction).

As a first example, when the magnet 77 is a permanent electromagnet, the current control unit 8b supplies a zero current to the beam 18a. No Lorentz force acts on the beam 18a. The beam 18a is not bent, and thereby the movable mirror 20 does not move in the horizontal direction. The horizontal displacement amount of the movable mirror 20 is zero. On the other hand, when the current control unit 8b supplies a non-zero current to the beam 18a, a Lorentz force acts on the beam 18a. The direction of the Lorentz force acting on the beam 18a is the first direction (x direction) perpendicular to the longitudinal direction (the second direction (y direction)) of the beam 18a in the portion of the beam 18a to which the pillar 23 is connected and the direction (the third direction (z direction)) of the magnetic field generated by the magnet 77 on the beam 18a. The beam 18a is bent in the first direction (x direction), and thereby the movable mirror 20 moves in the first direction (x direction). The horizontal displacement amount of the movable mirror 20 becomes non-zero.

As a second example, when the magnet 77 is an electromagnet, the current control unit 8b supplies a current to the beam 18a, and the magnetic field control unit 9e turns off the magnet 77. Since no magnetic field is generated by the magnet 77 on the beam 18a, no Lorentz force acts on the beam 18a. The beam 18a is not bent, and thereby the horizontal displacement amount of the movable mirror 20 is zero. On the other hand, the current control unit 8b supplies a current to the beam 18a, and the magnetic field control unit 9e turns on the magnet 77. Since a magnetic field is generated by the magnet 77 on the beam 18a, a Lorentz force acts on the beam 18a. The direction of the Lorentz force acting on the beam 18a is the first direction (x direction) perpendicular to the longitudinal direction (the second direction (y direction)) of the beam 18a in the portion of the beam 18a to which the pillar 23 is connected and the direction (the third direction (z direction)) of the magnetic field generated by the magnet 77 on the beam 18a. The beam 18a is bent in the first direction (x direction), and thereby the movable mirror 20 moves in the first direction (x direction). The horizontal displacement amount of the movable mirror 20 becomes non-zero.

The movement amount of each movable mirror 20 in the first direction (x direction) is changed for each movable mirror 20. Thus, the period of the plurality of first movable mirror arrays 4 and the period of the plurality of second movable mirror arrays 5 in the first direction (x direction) can be changed. For example, when the period of the plurality of first movable mirror arrays 4 and the period of the plurality of second movable mirror arrays 5 in the first direction (x direction) are made smaller, the diffraction angle θ becomes larger. When the period of the plurality of first movable mirror arrays 4 and the period of the plurality of second movable mirror arrays 5 in the first direction (x direction) are made larger, the diffraction angle θ becomes smaller. Those described above with respect to the beam 18a also applies to the beam 18b.

When the movable mirrors 20 of the plurality of movable mirror elements 3d are arranged as illustrated in FIG. 9, the diffraction angle θ can be changed by changing the period of the plurality of second movable mirror arrays 5 and the period of the plurality of second movable mirror arrays 5 in the second direction (y direction).

As a first example, when the magnet 77 is a permanent electromagnet, the current control unit 8b supplies a zero current to the beam 18b. No Lorentz force acts on the beam 18b. The beam 18b is not bent, and thereby the movable mirror 20 does not move in the horizontal direction. The horizontal displacement amount of the movable mirror 20 is zero. On the other hand, when the current control unit 8b supplies a non-zero current to the beam 18b, a Lorentz force acts on the beam 18b. The direction of the Lorentz force acting on the beam 18b is the second direction (y direction) perpendicular to the longitudinal direction (the first direction (x direction)) of the beam 18b in the portion of the beam 18b to which the pillar 23 is connected and the direction (the third direction (z direction)) of the magnetic field generated by the magnet 77 on the beam 18a. The beam 18b is bent in the second direction (y direction), and thereby the movable mirror 20 moves in the second direction (y direction). The horizontal displacement amount of the movable mirror 20 becomes non-zero.

As a second example, when the magnet 77 is an electromagnet, the current control unit 8b supplies a current to the beam 18b, and the magnetic field control unit 9e turns off the magnet 77. Since no magnetic field is generated by the magnet 77 on the beam 18b, no Lorentz force acts on the beam 18b. The beam 18b is not bent, and thereby the horizontal displacement amount of the movable mirror 20 is zero. On the other hand, the current control unit 8b supplies a current to the beam 18b, and the magnetic field control unit 9e turns on the magnet 77. Since a magnetic field is generated by the magnet 77 on the beam 18b, a Lorentz force acts on the beam 18b. The direction of the Lorentz force acting on the beam 18b is the second direction (y direction) perpendicular to the longitudinal direction (the first direction (x direction)) of the beam 18b in the portion of the beam 18b to which the pillar 23 is connected and the direction (the third direction (z direction)) of the magnetic field generated by the magnet 77 on the beam 18b. The beam 18b is bent in the second direction (y direction), and thereby the movable mirror 20 moves in the second direction (y direction). The horizontal displacement amount of the movable mirror 20 becomes non-zero.

The movement amount of each movable mirror 20 in the second direction (y direction) is changed for each movable mirror 20. Thus, the period of the plurality of first movable mirror arrays 4 and the period of the plurality of second movable mirror arrays 5 in the second direction (y direction) can be changed. For example, when the period of the plurality of first movable mirror arrays 4 and the period of the plurality of second movable mirror arrays 5 in the second direction (y direction) are made smaller, the diffraction angle θ becomes larger. When the period of the plurality of first movable mirror arrays 4 and the period of the plurality of second movable mirror arrays 5 in the second direction (y direction) are made larger, the diffraction angle θ becomes smaller. Those described above with respect to the beam 18a also applies to the beam 18b.

The optical scanning device 1e according to the present embodiment has the following effects in addition to the effects of the optical scanning device 1 according to the first embodiment.

In the optical scanning device 1e of the present embodiment, the in-plane driving unit 70e includes a second magnet (for example, the magnet 77) that generates a second magnetic field perpendicular to the main surface 2a of the substrate 2 on the beam (for example, the beam 18a). The beam is electrically conductive. Each of the plurality of movable mirror elements 3d includes a first electrode (for example, the electrode 12a) and a second electrode (for example, the electrode 12b). The first electrode and the second electrode are provided on the main surface 2a of the substrate 2, and are separated from each other. The first electrode is electrically connected to the first end of the beam. The second electrode is electrically connected to the second end of the beam.

Therefore, it is possible to change the deflection angle of the optical scanning device 1e in accordance with a current flowing through the beam (for example, the beam 18a) and the second magnetic field formed on the beam by the second magnet (for example, the magnet 77), which makes it possible for the optical scanning device 1e to change the area to be optically scanned.

### Sixth Embodiment

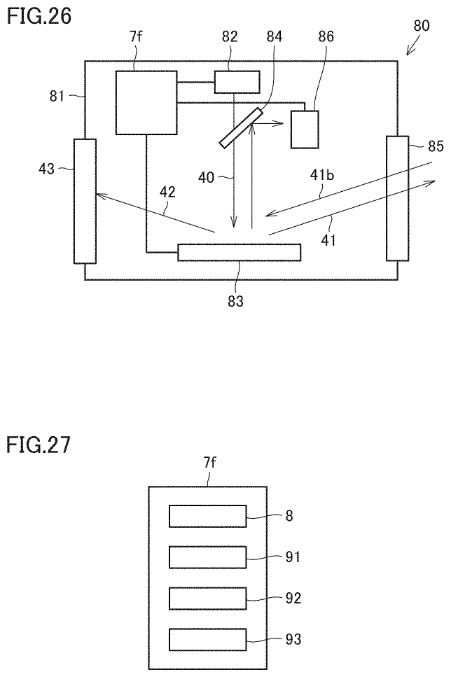

With reference to FIGS. 26 and 27, a distance measuring device 80 according to a sixth embodiment will be described. The distance measuring device 80 is, for example, a light detection and ranging measurement (LiDAR) system.

As illustrated in FIG. 26, the distance measuring device 80 includes a light source 82, an optical scanning device 83, and a light receiver 86. The distance measuring device 80 may further include a beam splitter 84, a case 81, a transparent window 85, and a light shielding member 43.

The light source 82 emits a light beam 40 toward the optical scanning device 83. The light source 82 is, for example, a laser light source such as a semiconductor laser. The light beam 40 emitted from the light source 82 is, for example, a laser light. The light beam 40 emitted from the light source 82 may have a wavelength within a near infrared wavelength range of 800 nm to 1600 nm. A light beam within the near infrared wavelength range is less susceptible to sunlight and is harmless to human eyes. Therefore, a light beam in the near infrared wavelength region is preferable as the light beam 40 to be used for the distance measuring device 80. The light beam 40 emitted from the light source 82 may be a terahertz wave having a wavelength of 30 μm or more and 1000 μm or less. Since the terahertz wave is harmless to human body and has high transparency to an object, it is preferable as the light beam to be used for the distance measuring device 80.

Specifically, the light source 82 may be a wavelength variable light source. The light source 82 may be, for example, a wavelength variable semiconductor laser. The light source 82 emits the light beam 40 in, for example, the third direction (z direction). The light beam 40 emitted from the light source 82 passes through the beam splitter 84 and is incident on the optical scanning device 83.

The optical scanning device 83 is, for example, any one of the optical scanning devices 1, 1b, 1c, 1d and 1e according to the first to fifth embodiment, respectively. The light scanning device 83 diffracts the light beam 40 emitted from the light source 82 toward the periphery of the distance measuring device 80 and scans the periphery with the light beam.

The light beam emitted to the periphery of the optical scanning device 83 (for example, the +1 order diffraction light beam 41) is reflected or diffusely reflected by an object located in the periphery of the optical scanning device 83. The light receiver 86 receives a light beam 41b reflected or diffusely reflected from the periphery of the distance measuring device 80. Specifically, the light beam 41b reflected or diffusely reflected from the periphery of the distance measuring device 80 returns to the optical scanning device 83. The light beam 41b reflected or diffusely reflected from the periphery of the distance measuring device 80 is diffracted by the light scanning device 83, reflected by the beam splitter 84, and incident on the light receiver 86. The light receiver 86 is, for example, a photodiode.

The case 81 houses the light source 82, the optical scanning device 83, the light receiver 86, and the beam splitter 84. The case 81 may be provided with a transparent window 85. The transparent window 85 transmits the +1 order diffraction light beam 41 diffracted by the optical scanning device 83 and the light beam 41b reflected or diffusely reflected from the periphery of the distance measuring device 80. The transparent window 85 is made of transparent glass or transparent resin. The case 81 may be provided with a light shielding member 43. The light shielding member 43 is the same as that described in the first embodiment.

The controller 7f is communicably connected to the light source 82. As illustrated in FIG. 27, the controller 7f includes a light source control unit 91. The light source control unit 91 controls the light source 82, i.e., controls a light emission timing or a light emission rate of the light source 82. The controller 7f is communicably connected to the light receiver 86. The controller 7f includes a distance calculation unit 92. The controller 7f receives a signal from the light receiver 86. The distance calculation unit 92 is configured to process the signal so as to calculate a distance from an object located in the periphery of the distance measuring device 80 to the distance measuring device 80. When the light shielding member 43 is an optical shutter, the controller 7f includes an optical shutter control unit 93. The optical shutter control unit 93 controls an optical transmittance of the optical shutter.

The controller 7f may further include a voltage control unit 8 or the like depending on the configuration of the optical scanning device 83. For example, when the optical scanning device 83 is the optical scanning device 1 of the first embodiment, the controller 7f further includes the voltage control unit 8 of the first embodiment.

The distance measuring device 80 according to the present embodiment has the following effects in addition to the effects of the optical scanning device 1 according to the first embodiment.

The distance measuring device 80 of the present embodiment includes a light source 82, an optical scanning device 83, and a light receiver 86. The light scanning device 83 diffracts the light beam 40 emitted from the light source 82 toward the periphery of the distance measuring device 80 and scans the periphery with the light beam. The light receiver 86 receives the light beam 41b reflected or diffusely reflected from the periphery of the distance measuring device 80.

The distance measuring device 80 includes an optical scanning device 83 capable of performing an optical scanning with a light beam at a higher speed. Therefore, the distance measuring device 80 can measure the distance of an object in the periphery of the distance measuring device 80 more quickly. The distance measuring device 80 includes an optical scanning device 83 capable of performing an optical scanning with a light beam at a larger deflection angle. Therefore, the distance measuring device 80 can more easily measure the distance of an object in the periphery of the distance measuring device 80.

In the distance measuring device 80 of the present embodiment, the light source 82 is a wavelength variable light source. The diffraction angle of the light beam diffracted by the light scanning device 83 (the deflection angle of the light scanning device 83) can be changed by changing the wavelength of the light beam emitted from the light source 82. The distance measuring device 80 can measure the distance of an object in the periphery thereof over a wider area.

It should be understood that the first embodiment to the sixth embodiment disclosed herein are illustrative and not restrictive in all respects. At least two of the first embodiment to the sixth embodiment disclosed herein may be combined unless they are inconsistent to each other. For example, the in-plane driving unit 70 of the fourth embodiment or the in-plane driving unit 70e of the fifth embodiment may be added to the optical scanning device 1b of the second embodiment or the optical scanning device 1c of the third embodiment. It is intended that the scope of the present invention is not limited to the description above but defined by the scope of the claims and encompasses all modifications equivalent in meaning and scope to the claims.

### REFERENCE SIGNS LIST

1, 1b, 1c, 1d, 1e, 83: optical scanning device; 2: substrate; 2a: main surface; 3, 3b, 3c, 3d: movable mirror element; 4: first movable mirror array; 5: second movable mirror array; 7, 7b, 7c, 7d, 7e, 7f: controller; 8, 8c, 8d: voltage control unit; 8b: current control unit; 9b, 9e: magnetic field control unit; 10: conductive substrate; 11: first insulating film; 12a, 12b, 12c, 12d, 14: electrode; 13a, 13b, 13c, 13d, 15, 72a, 72b, 72c, 72d: wiring; 17a, 17b, 17c, 17d: anchor; 18a, 18b: beam; 20: movable mirror; 21: movable plate; 22: mirror film; 23: pillar; 24: second insulating film; 30: sacrificial layer; 31: hole; 33: silicon substrate; 34: insulating film; 35: silicon layer; 36: SOI substrate; 40, 41b: light beam; 41: +1 order diffraction light beam; 42: −1 order diffraction light beam; 43: light shielding member; 51, 52, 53, 54, 77: magnet; 61, 62, 63, 64: piezoelectric film; 70, 70e: in-plane driving unit; 71a, 71b, 71c, 71d: comb-shaped electrode; 73a, 73b, 73c, 73d: driving electrode; 74a, 74b, 74c, 74d: comb-shaped electrode; 80: distance measuring device; 81: case; 82: light source; 84: beam splitter; 85: transparent window; 86: light receiver; 91: light source control unit; 92: distance calculation unit; 93: optical shutter control unit

1. An optical scanning device comprising:
a substrate including a main surface that extends in a first direction and a second direction perpendicular to the first direction; and
a plurality of movable mirror elements two-dimensionally arranged on the main surface in a plan view of the main surface,
the plurality of movable mirror elements being capable of operating independently of each other and capable of forming a diffraction grating,
each of the plurality of movable mirror elements including:
a beam that is bendable in a third direction perpendicular to the main surface;
a first anchor that is provided on the main surface to support a first end of the beam;
a second anchor that is provided on the main surface to support a second end of the beam opposite to the first end thereof;
a movable mirror that includes a movable plate separated from the beam in the third direction and a mirror film disposed on the movable plate;
a pillar that connects the movable plate and a portion of the beam other than the first end and the second end to each other; and
a controller that controls a vertical displacement amount of the movable mirror in the third direction, wherein
the controller constructs a plurality of first movable mirror arrays and a plurality of second movable mirror arrays from the plurality of movable mirror elements,
the plurality of first movable mirror arrays are constructed from a part of the plurality of movable mirror elements in which the vertical displacement amount of the movable mirror is a first vertical displacement amount,
the plurality of second movable mirror arrays are constructed from a remaining part of the plurality of movable mirror elements in which the vertical displacement amount of the movable mirror is a second vertical displacement amount which is larger than the first vertical displacement amount,
in the plan view of the main surface, a first longitudinal direction of each of the plurality of first movable mirror arrays is parallel to a second longitudinal direction of each of the plurality of second movable mirror arrays,
the plurality of first movable mirror arrays and the plurality of second movable mirror arrays are arranged alternately and periodically in a direction perpendicular to the first longitudinal direction, and
in the plan view of the main surface, the controller is capable of changing the first longitudinal direction and the second longitudinal direction.

2. (canceled)

3. The optical scanning device according to claim 1, wherein
an absolute value u of a difference between the first vertical displacement amount and the second vertical displacement amount is given by the following equation (1):
u=(¼+n/2)λ (1)
wherein λ represents a wavelength of a light beam incident on the plurality of movable mirror elements, and n represents zero or a natural number.

4. The optical scanning device according to claim 3, wherein
the absolute value u satisfies the following expression (2):
u≥W/tan θ (2)
wherein W represents an interval between a pair of first movable mirror arrays adjacent to each other among the plurality of first movable mirror arrays, and 0 represents a diffraction angle of the light beam diffracted by the plurality of movable mirror elements.

5. The optical scanning device according to claim 1, wherein
in the plan view of the main surface, the movable mirror has a square shape.

6. The optical scanning device according to claim 1, wherein
in the plan view of the main surface, the movable mirror has a regular triangular shape.

7. The optical scanning device according to claim 1, further comprising:
a light shielding member that blocks one of a pair of light beams diffracted by the diffraction grating.

8. The optical scanning device according to claim 7, wherein
the light shielding member is an optical shutter.

9. The optical scanning device according to claim 1, wherein
the beam is electrically conductive,
each of the plurality of movable mirror elements includes a first electrode and a second electrode,
the first electrode and the second electrode are provided on the main surface, and are electrically insulated from each other,
the first electrode is electrically connected to the beam, and
the second electrode is opposed to the pillar and the portion of the beam in the third direction.

10. The optical scanning device according to claim 1, further comprising:
a first magnet that generates a first magnetic field along the main surface on the beam,
the beam is electrically conductive,
each of the plurality of movable mirror elements includes a first electrode and a second electrode,
the first electrode and the second electrode are provided on the main surface, and are separated from each other,
the first electrode is electrically connected to the first end of the beam, and
the second electrode is electrically connected to the second end of the beam.

11. The optical scanning device according to claim 1, wherein
the plurality of movable mirror elements include a piezoelectric film provided on the beam.

12. The optical scanning device according to claim 1, further comprising:
an in-plane driving unit that drives the beam to move in at least one direction of the first direction or the second direction.

13. The optical scanning device according to claim 12, wherein
the beam is electrically conductive,
the in-plane driving unit includes a first comb-shaped electrode provided on the beam, a driving electrode provided on the main surface, and a second comb-shaped electrode provided on the driving electrode, and
the first comb-shaped electrode and the second comb-shaped electrode are opposed to each other.

14. The optical scanning device according to claim 12, wherein
the in-plane drive section includes a second magnet that generates a second magnetic field perpendicular to the main surface on the beam,
the beam is electrically conductive,
each of the plurality of movable mirror elements includes a first electrode and a second electrode,
the first electrode and the second electrode are provided on the main surface, and are separated from each other,
the first electrode is electrically connected to the first end of the beam, and
the second electrode is electrically connected to the second end of the beam.

15. A distance measuring device, comprising:
a light source;
the optical scanning device according to claim 1 that diffracts a light beam emitted from the light source toward a periphery of the distance measuring device and scans the same; and
a light receiver that receives the light beam reflected or diffusely reflected from the periphery of the distance measuring device.

16. The distance measuring device according to claim 15, wherein
the light source is a wavelength variable light source.
